(19) United States
(12) Patent Application Publication
(10) Pub. No.: US 2012/0119477 A1
(43) Pub. Date: May 17, 2012

(54) COMBINED STRUCTURE OF OUTER UPPER CENTER PILLAR REINFORCEMENT AND SEAT BELT BRACKET

(75) Inventor: Do Hoi Kim, Uiwang-si (KR)

(73) Assignee: Hyundai Motor Company, Seoul (KR)

(21) Appl. No.: 13/221,690

(22) Filed: Aug. 30, 2011

(30) Foreign Application Priority Data
Nov. 12, 2010 (KR) 10-2010-0113033

(51) Int. Cl. B60R 22/20; B62D 25/04

(52) U.S. Cl. 280/801.2; 296/193.06

(57) ABSTRACT

A combined structure of the outer upper center pillar reinforcement and the seat belt bracket is provided. An outer upper center pillar reinforcement is mounted on a panel of a vehicle body, and is provided with protruding portions at both ends thereof inside a vehicle, and a coupling portion formed between the protruding portions. The seat belt bracket is coupled to the outer upper center pillar reinforcement by welding, thereby improving the coupling force and the safety.

### CROSS-REFERENCE TO RELATED APPLICATION

This application is based on and claims priority from Korean Patent Application Number 10-2010-0113033 filed Nov. 12, 2010, the entire contents of which application is incorporated herein for all purposes by this reference.

### BACKGROUND OF INVENTION

1. Field of Invention

The present invention relates to a combined structure of an outer upper center pillar reinforcement and a seat belt bracket, and more particularly, to a combined structure of an outer upper center pillar reinforcement and a seat belt bracket which can improve coupling strength when the outer upper reinforcement mounted on a vehicle is coupled to the seat belt bracket.

2. Description of Related Art

In general, a mounting device is provided between a front door and a rear door of a vehicle to support a seat belt on a center pillar serving as a pillar.

In this instance, the center pillar has a big impact on a degree of an injury of a passenger depending upon a deformation mode at the time of lateral collision. In order to increase the structure strength of the center pillar at the time of lateral collision, a reinforcing member such as reinforcement is mounted on the center pillar.

FIGS. 1 and 2 are cross-sectional views illustrating a structure of a center pillar for a vehicle in the related art.

The structure of the center pillar for the vehicle in the related art includes, as shown in FIGS. 1 and 2, inner and outer panels 2 and 3, and a reinforcing panel 4 interposed between the inner and outer panels 2 and 3.

More specifically, the outer panel 2 is provided on a center pillar 1 of the vehicle, and the inner panel 3 is coupled to the outer panel 2 to form a constant space. The reinforcing panel 4 is interposed between the outer panel 2 and the outer panel 3 to reinforce the strength thereof.

The reinforcing panel 4 is coupled to a position adjacent to the outer panel 2 of the center pillar 1 to reinforce the strength thereof. An additional reinforcing member 6 is provided to come into contact with the reinforcing panel 4, thereby tightening up passage protection at the time of lateral collision.

In this instance, the additional reinforcing member 6 is provided adjacent to the reinforcing panel 4 in various forms, as shown in the drawing. The additional reinforcing member 6 is coupled to the outer panel 2 and the inner panel 3 by welding.

In addition, the center pillar 1 is provided therein with a mounting member 5 for adjusting the height of the seat belt. The mounting member 5 is positioned to come into contact with the inner panel 3.

The mounting member 5 is provided with a plurality of fastening holes 5a which are spaced apart from each other at regular intervals. The inner panel 3 is provided with a plurality of engaging holes 3a corresponding to the fastening holes 5a, so that the mounting member 5 is fixed to the inner panel 3 by the welding.

However, the structure of the center pillar in the related art has a problem in that since the engaging strength of the mounting member for coupling the center pillar which is mounted on the vehicle and the seat belt is low, the mounting member is likely to be broken at the time of welding coupling.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made to address the above-mentioned problems occurring in the prior art while advantages achieved by the prior art are maintained intact.

Various aspects of the present invention provide for a combined structure of an outer upper center pillar reinforcement and a seat belt bracket which can improve coupling strength when the outer upper reinforcement mounted on a vehicle is coupled to the seat belt bracket.

In one aspect of the present invention, there is provided a combined structure of an outer upper center pillar reinforcement and a seat belt bracket, which includes the outer upper center pillar reinforcement mounted on a panel of a vehicle body and provided with protruding portions at both ends thereof and a coupling portion formed between the protruding portions, and the seat belt bracket inserted into the coupling portion and coupled to the outer upper center pillar reinforcement by welding.

According to various aspects of the present invention as constructed above, the combined structure of the outer upper center pillar reinforcement and the seat belt bracket can improve the strength by increasing the coupling force, thereby improving the merchantable quality and the safety.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1 and 2 are cross-sectional views illustrating a structure of a center pillar for a vehicle in the related art.

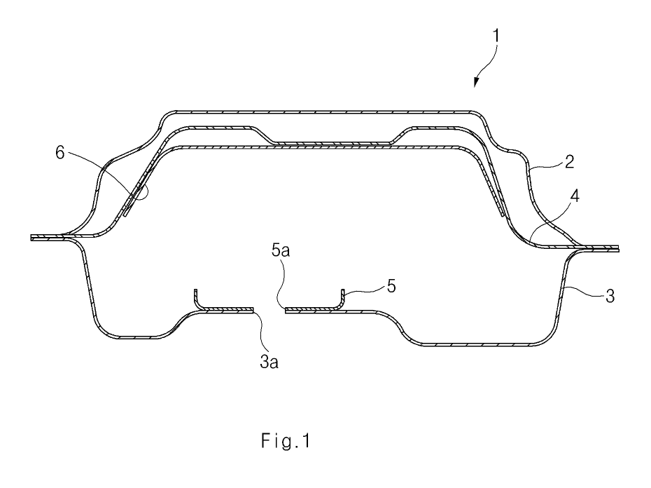

FIG. 3 is a cross-sectional view illustrating an outer upper center pillar reinforcement and a welding gun in an exemplary structure of coupling the outer upper center pillar reinforcement and a seat belt bracket according to the present invention.

FIG. 4A is a cross-sectional view illustrating an exemplary structure of coupling the outer upper center pillar reinforcement and a seat belt bracket according to the present invention before the outer upper center pillar reinforcement is coupled to the seat belt bracket.

FIG. 4B is a cross-sectional view illustrating an exemplary structure of coupling the outer upper center pillar reinforcement and a seat belt bracket according to the present invention after the outer upper center pillar reinforcement is coupled to the seat belt bracket.

FIGS. 5A and 5B are views illustrating an exemplary seat belt bracket which is coupled to an outer upper center pillar reinforcement in a structure of coupling the outer upper center pillar reinforcement and the seat belt bracket according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

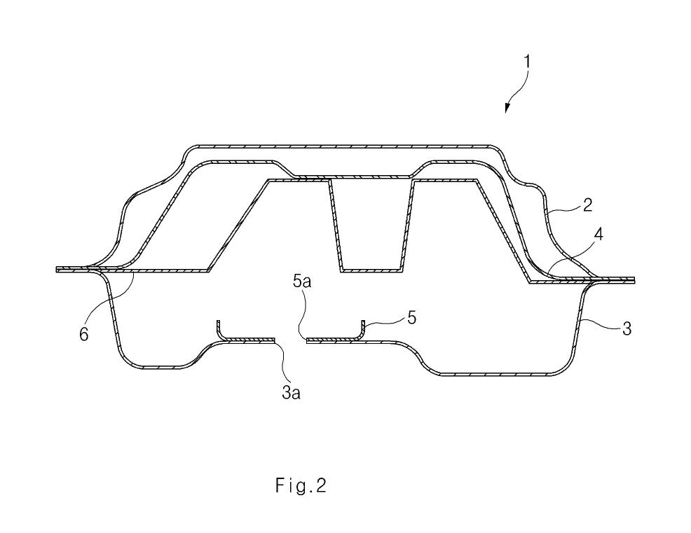

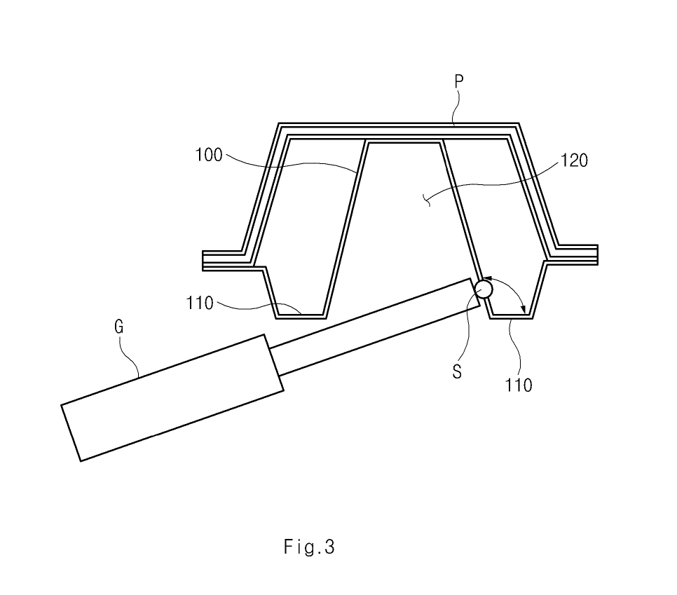

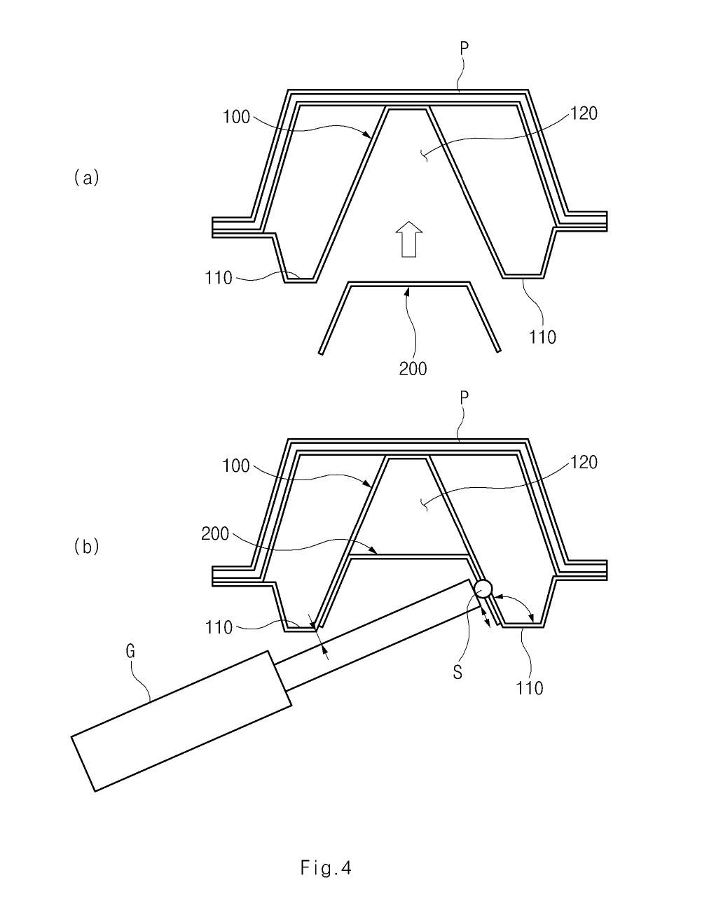

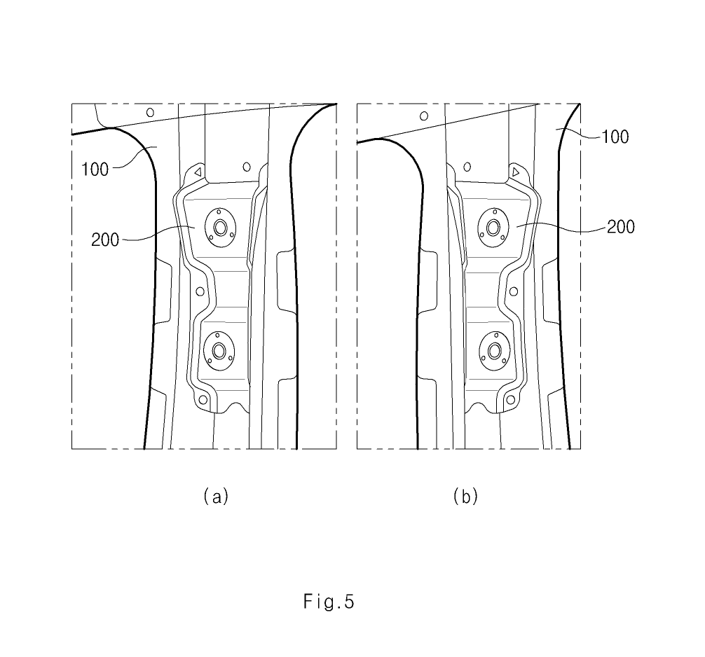

FIGS. 3 to 5B show a combined structure of an outer upper center pillar reinforcement and a seat belt bracket according to the present invention. FIG. 3 is a cross-sectional view illustrating the outer upper center pillar reinforcement and a welding gun in a structure of coupling the outer upper center pillar reinforcement and the seat belt bracket according to the present invention. FIG. 4A is a cross-sectional view illustrating the structure of coupling the outer upper center pillar reinforcement and the seat belt bracket according to the present invention before the outer upper center pillar reinforcement is coupled to the seat belt bracket. FIG. 4B is a cross-sectional view illustrating the structure of coupling the outer upper center pillar reinforcement and the seat belt bracket according to the present invention after the outer upper center pillar reinforcement is coupled to the seat belt bracket. FIGS. 5A and 5B are views illustrating the seat belt bracket which is coupled to an outer upper center pillar reinforcement in the structure of coupling the outer upper center pillar reinforcement and the seat belt bracket according to the present invention.

A combined structure of the outer upper center pillar reinforcement and the seat belt bracket according to the present invention is characterized in that the outer upper center pillar reinforcement 100 is provided with W-shaped protruding portions 110 at both ends thereof inside the vehicle, and a coupling portion 120 formed between the protruding portions 110, and the seat belt bracket 200 is coupled to the outer upper center pillar reinforcement 100, thereby improving the coupling force.

Each component of the combined structure of the outer upper center pillar reinforcement and the seat belt bracket according to the present invention will now be described with reference to the accompanying drawings.

The outer upper center pillar reinforcement 100 mounted on a panel P of the vehicle body is coupled to the seat belt bracket 200 by welding.

As shown in FIG. 3, the outer upper center pillar reinforcement 100 is interposed between a front door and a rear door in the exterior panel P of the vehicle body. The outer upper center pillar reinforcement 100 is formed in the shape of W character.

In this instance, the W-shaped outer upper center pillar reinforcement 100 is provided with the plurality of protruding portions 110 at both ends thereof in an inward direction (lower portion in FIGS. 3 and 4), and the coupling portion 120 formed between the protruding portions 110, so that the outer upper center pillar reinforcement can be coupled to the seat belt bracket 200 which will be described below.

The seat belt bracket 200 is formed in the shape of n character, and is inserted into the coupling portion 120. The seat belt bracket 200 is coupled to the outer upper center pillar reinforcement 100 by the welding.

As shown in FIG. 4A, it is desirable that the coupling portion 120 of the outer upper center pillar reinforcement 100 is disposed toward the seat belt bracket 200 at a predetermined slant angle, so that the seat belt bracket 200 is inserted into the outer upper center pillar reinforcement 100.

In this instance, if an inner angle of the protruding portion 110 formed on the outer upper center pillar reinforcement 100 is an obtuse angle, it is possible to easily carry out the coupling and the welding of the outer upper center pillar reinforcement 100 and the seat belt bracket 200.

Meanwhile, when a welding gun G is inserted between the outer upper center pillar reinforcement 100 and the seat belt bracket 200 so as to carry out the welding, the welding is performed in the state in which the welding gun G is spaced apart from the protruding portion 110 of the outer upper center pillar reinforcement 100 at a desired distance.

It is desirable that the interval between the welding gun G and the protruding portion 110 formed on the outer upper center pillar reinforcement 100 is 3 mm or more so as to easily carry out the welding.

As shown in FIG. 4B, a welding point S, at which the outer upper center pillar reinforcement 100 is welded to the seat belt bracket 200, is formed at a position spaced apart from an end portion of the seat belt bracket 200 at a predetermined interval to improve the coupling performance.

As shown in FIGS. 5A and 5B, the middle portion of the seat belt bracket 200 is bent, and the upper end, the middle portion, and the lower end of the seat belt bracket 200 are preferably coupled to the outer upper center pillar reinforcement 100 through two-spot welding, respectively.

The operation and effect of the present invention will now be described.

As shown in FIGS. 3 and 4, the outer upper center pillar reinforcement is formed in the shape of W character, and both ends are bent in the inward direction of the vehicle to form the protruding portions 110. The coupling portion 120 is formed between the protruding portions 110, so that the seat belt bracket 200 is able to be coupled to the outer upper center pillar reinforcement 100.

In addition, the inner angle of the protruding portion 110 formed on the outer upper center pillar reinforcement 100 is an obtuse angle, and the coupling portion 120 of the outer upper center pillar reinforcement 100 is disposed toward the seat belt bracket 200 at a predetermined slant angle. Therefore, the seat belt bracket 200 is inserted into the outer upper center pillar reinforcement 100 and then is welded thereto.

Meanwhile, the welding operation is carried out in the state in which the welding gun G is spaced apart from the protruding portion 110 of the outer upper center pillar reinforcement 100 at a desired distance. As a result, the welding point S is formed at a position spaced apart from the end of the seat belt bracket 200 at a predetermined interval, thereby improving the coupling performance and thus increasing a shearing force to improve the coupling strength.

In addition, as shown in FIGS. 5A and 5B, the outer upper center pillar reinforcement 100 and the seat belt bracket 200 are coupled to each other at the upper end, the middle portion, and the lower end of the seat belt bracket 200 through two-spot welding to improve the coupling performance.

With the combined structure of the outer upper center pillar reinforcement and the seat belt bracket, the outer upper center pillar reinforcement is mounted on the panel of the vehicle body, and is provided with the protruding portions at both ends thereof in the inward direction of the vehicle, and the coupling portion is formed between the protruding portions. The seat belt bracket is inserted into the coupling portion, and is coupled to the outer upper center pillar reinforcement by welding. As a result, the coupling force of the outer upper center pillar reinforcement and the seat belt bracket, thereby improving the merchantable quality and the safety.

For convenience in explanation and accurate definition in the appended claims, the terms upper or lower, front or rear, inside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A combined structure of an outer upper center pillar reinforcement and a seat belt bracket, comprising:
an outer upper center pillar reinforcement mounted on a panel of a vehicle body, and provided with protruding portions at both ends thereof and a coupling portion formed between the protruding portions; and
a seat belt bracket inserted into the coupling portion, and coupled to the pillar reinforcement by welding.

2. The combined structure according to claim 1, wherein the coupling portion of the pillar reinforcement is disposed toward the seat belt bracket at a predetermined slant angle, so that the seat belt bracket is inserted into the pillar reinforcement.

3. The combined structure according to claim 1, wherein an inner angle of at least one of the protruding portions formed on the pillar reinforcement is an obtuse angle

4. The combined structure according to claim 1, wherein when a welding gun is inserted between the pillar reinforcement and the seat belt bracket so as to carry out welding, the welding gun is spaced apart from the protruding portion of the pillar reinforcement at a desired distance.

5. The combined structure according to claim 1, wherein a welding point, at which the pillar reinforcement is welded to the seat belt bracket, is formed at a position spaced from an end portion of the seat belt bracket at a predetermined distance.

6. The combined structure according to claim 5, wherein a middle portion of the seat belt bracket is bent, and an upper end, the middle portion, and a lower end of the seat belt bracket are coupled to the pillar reinforcement through two-spot welding, respectively.
